(19) United States
(12) Patent Application Publication
(10) Pub. No.: US 2020/0172072 A1
(43) Pub. Date: Jun. 4, 2020

(54) METHOD FOR ENGAGING A PARKING LOCK OF A MOTOR VEHICLE, AND MOTOR VEHICLE

(71) Applicant: AUDI AG, Ingolstadt (DE)

(72) Inventors: Kilian FOERSTER, Beilngries (DE); Martin SCHWINDL, München (DE)

(73) Assignee: AUDI AG, Ingolstadt (DE)

(21) Appl. No.: 16/630,607

(22) PCT Filed: Jul. 16, 2018
(86) PCT No.: PCT/EP2018/069252

§ 371 Date: Jan. 13, 2020

(30) Foreign Application Priority Data
Aug. 25, 2017 (DE) 10 2017 214 904.3

(51) Int. Cl. B60T 13/66; B60L 7/00; B60T 17/18; B60T 7/04; B60T 1/00; B60L 3/00

(52) U.S. Cl. CPC B60T 13/665; B60L 7/006; B60L 3/0076; B60T 7/042; B60T 1/005; B60T 17/18

(57) ABSTRACT

A method for engaging a parking lock of a motor vehicle having a service brake and a parking brake, in which the parking lock is engaged, while by means of a braking device of the motor vehicle, the rolling away of the motor vehicle is at least restricted, wherein as the braking device, an additionally provided braking device of the motor vehicle, different from the service brake and from the parking brake, is used.

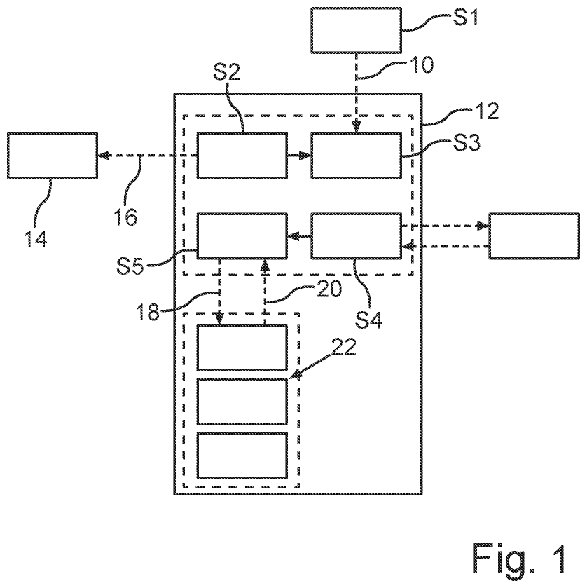

### DESCRIPTION

The invention relates to a method for engaging a parking lock of a motor vehicle according to the preamble of patent claim 1. Furthermore, the invention relates to a motor vehicle having the features of claim 12.

Such a method for engaging a parking lock of a motor vehicle and such a motor vehicle, are already known, for example, from US 20160355165 A1 or from WO 2015128082 A1. The example of a car, in particular a motor vehicle designed as passenger car, comprises the parking lock, a service brake, and a parking brake. In the context of the method, it is provided that the parking lock is engaged, when by means of a braking device of a motor vehicle, the rolling away of the motor vehicle is at least restricted.

Furthermore, DE 10 2009 023 498 B4 discloses a parking lock assembly for a motor vehicle.

The object of the present invention is to create a method and a motor vehicle of the type mentioned at the beginning, so that the weight and cost of the motor vehicle can be kept particularly low.

According to the invention, this object is achieved by a method having the features of claim 1, as well as by a motor vehicle having the features of claim 12. Advantageous embodiments with expedient developments of the invention are specified in the remaining claims.

A first aspect of the invention relates to a method for engaging or activating a parking lock of a motor vehicle, in particular of a car and preferably a passenger car. The motor vehicle comprises the parking lock, a service brake and a parking brake. The service brake is also referred to as a service brake system and is used to slow down the motor vehicle during normal operation and to bring it to its standstill. For this purpose, the service brake can be actuated, for example, by the driver of the motor vehicle, in particular by foot, while the driver actuates a brake pedal, in particular pushes it, for example, with his foot. Also, the parking brake is usually referred to as a locking brake and is not usually used, in contrast to the service brake, to slow down the motor vehicle during normal operation and if necessary to brake it to a standstill, but to permanently block the motor vehicle, in particular its wheels, and thus to secure the motor vehicle in its standstill and thus against rolling away. In particular, it is provided that the parking brake is designed as an electric parking brake or electric locking brake.

The parking lock comprises, for example, at least one parking pawl, which is, for example, at least indirectly movably mounted on a housing, in particular, of a transmission of the motor vehicle and is movable relative to the housing, in particular pivotably, between at least one release position and at least one locking position. In the locking position, for example, the parking pawl engages with a corresponding recess, which is provided, for example, on a shaft, in particular on a transmission shaft of the transmission. In doing so, the shaft is, for example, at least indirectly coupled to at least one wheel or to multiple wheels of the motor vehicle. If the parking pawl engages with the corresponding recess, the shaft is secured against rotation relative to said housing, whereby the wheel or wheels are secured against undesired rotation. As a result, the motor vehicle is secured against undesired rolling away, in particular in a form-fitting manner. The recess is formed, for example, by a parking lock wheel, which may be non-rotatably connected to the shaft or integrally formed with the shaft.

As engaging the parking lock, it is to be understood in particular that, for example, that the parking pawl is moved from the release position into the locking position. In the release position, the parking pawl is arranged completely outside the recess. In other words, the parking pawl in the release position does not engage with the recess, so that the shaft and consequently the wheel or the wheels can rotate. In the method, the parking lock is engaged, when by means of a braking device of the motor vehicle, the rolling away of the motor vehicle is at least restricted.

In order to then be able to keep the weight and cost of the motor vehicle particularly low, it is provided according to the invention that as the braking device, by means of which the rolling away of the motor vehicle is at least restricted when the parking lock is engaged, an additionally provided braking device of the motor vehicle, different from the service brake and from the parking brake, is used.

While in conventional methods and motor vehicles, only an error-free normal condition of the motor vehicle is considered, the method according to the invention also takes into account a possible error or error condition of the motor vehicle, wherein in the context of the error, for example, the parking brake designed in particular as an electronic parking brake andor the service brake fails and is thus not available or cannot be used, in particular when the parking lock is engaged, in order to at least restrict the rolling away of the motor vehicle. Since in conventional methods or motor vehicles such an error case is not taken into account, the parking lock, in particular the parking pawl, must be designed to be particularly massive and thus heavy and costly in conventional motor vehicles, since a condition can arise, for example in the event of failure of the service brake andor the parking brake, in which the motor vehicle rolls and thus moves at a low speed when the parking lock is engaged. Here, for example, the above-mentioned parking lock wheel rotates while the parking pawl is moved into the recess, which can lead to very high loads on the parking lock. Thus, in conventional motor vehicles, in order that the parking lock can withstand the above-mentioned high loads without damage even in the event of an error case, usually the parking lock must be designed particularly massive and thus heavy and costly.

However, this can now be avoided by means of the method according to the invention, since, even in the case of the service brake andor the parking brake failure, an excessive rolling motion and thus an excessive speed of the motor vehicle can be avoided when the parking lock is engaged. For this purpose, by means of said braking device, the rolling away of the motor vehicle is at least restricted, in particular prevented, so that the motor vehicle does not move or does not move excessively when the parking lock is engaged. As a result, the parking lock can be designed particularly slender and therefore weight and cost effectively, so that the weight and the cost of the motor vehicle can be kept overall in a particularly low frame.

In particular, the invention is based on the following finding: by means of the service brake, preferably designed as a hydraulic service brake, the motor vehicle is usually braked into a standstill, in particular by its driver, and then held at a standstill. In today's transmissions, in particular those designed as automatic transmissions, the motor vehicle is secured via the parking lock, also known as gear lock, in combination with the parking brake, which is designed, for example, as an electric parking brake (EPB). The service brake, the parking lock, and the parking brake are systems that conventionally act at least mostly independently of one another. This results in each system being designed as safely as possible. There, usually, in particular the parking lock, in particular the parking pawl, is designed in such a way that normally the parking lock is engaged only when, for example, a parking lever is brought into a parking position or the driver leaves the motor vehicle when the parking lever is in a forward drive- or reverse drive stage. If the motor vehicle is still in motion at this time, the parking lock is usually designed in such a way that the parking pawl does not engage with the recess and ratchets thereover or over the parking lock wheel. The parking lock is designed thus intrinsically safe. Blocking due to the incorrectly retracting or engaged parking lock is thus prevented.

With increasing electrification of motor vehicles, conventional concepts can no longer be adopted for the parking lock, wherein in particular bi-stationary actuators are developed, by means of which the parking lock, in particular the parking pawl, can be actively engaged and disengaged.

Due to the massive design of the parking lock, this has an elaborate and thus cost and weight-intensive construction. Here, components are to be provided, which enable the described ratcheting. Furthermore, conventionally, load cases are to be considered, in which the parking pawl is connected or is engaged while the motor vehicle is still moving. Here, this results in a high load acting on the parking lock, which is to be considered when constructing the parking lock. For disengaging the parking lot, that is, for example, for moving the parking pawl from the locked position into the release position, an increased force, in particular tractive force, is further required, which is to be applied to the parking pawl, for example, by an actuator in order to disengage it, because the parking lock is under load or strained. Furthermore, an independent disengaging of the parking lock should be avoided. This usually requires an indentation on the parking pawl and in the recess. This results in, for example, the use of a separate gear wheel for the parking lock, wherein the gear wheel is, for example, the above-mentioned parking lock wheel. As a result, conventional parking locks, inclusive of the actuator, are space-, cost- and weight intensive.

These problems or disadvantages can now be avoided by means of the method according to the invention, since in the context of the method according to the invention, the braking device different from the service brake, the parking brake and the parking lock is used in order to secure the motor vehicle at its standstill or at least restrict the rolling away of the motor vehicle, so that - when the parking lock is engaged - the car is stationary or an excessive movement of the car is avoided. In particular, the rolling away of the motor vehicle is at least restricted until the parking lock, in particular the parking pawl, is fully retracted.

By means of the method according to the invention, it can be ruled out that the parking lock is engaged when the motor vehicle moves excessively. Thus, conventionally provided security measures can be omitted, so that the parking lock, particularly the parking pawl, can be designed slender and thus cost- and weight effectively. In particular, it is possible, to engage the parking lock, in particular in a normal case, load-free and to disengage it at least almost load-free , so that the parking lock can be dimensioned particularly weight and cost effectively. Furthermore, for example, it is possible to use no additional, separate parking lock wheel or gear wheel for the realization of said recess, but the recess can be formed, for example, by a gear wheel, provided in any case, or by a shaft, provided in any case. Furthermore, it is possible, for example, instead of the parking pawl, also referred to as pawl, to use a space-, weight- and cost effective pin, which can be moved, for example, between the release position and the locking position translationally, in particular relative to the housing. Furthermore, for example, when the transmission is designed as a self-locking transmission, the above-mentioned indentation can be avoided, so that overall the parking lock or the motor vehicle can be designed particularly cost effectively.

If, for example, an actuator, in particular an electrically operated actuator, is used to move the parking pawl or the pin between the release position and the locking position, this can be designed by the fact that the parking pawl or the pin can be engaged andor disengaged particularly low-loaded or even load-free manner, particularly space-, weight- and cost effectively. In addition, the parking pawl or the pin or the parking lock can be installed or arranged particularly advantageously overall, wherein the parking lock can be arranged, for example, in a transmission, a differential, directly on an engine designed for driving the motor vehicle or on an axis.

In order to be able to keep the number of parts and thus the weight and the cost of the motor vehicle particularly low, it is provided in an advantageous design of the invention that the braking device comprises at least one electric motor designed for driving the motor vehicle, by means of which the rolling away of the motor vehicle is at least restricted in such a way that by means of the electric motor at least one shaft of the motor vehicle is moved several times alternately in a first rotational direction and in a second rotational direction opposite to the first rotational direction. In other words, for example, the shaft, is alternately moved back and forth by means of the electric motor, in particular having a particularly high frequency, in order to thereby avoid, for example, the rolling away or an excessively fast rolling of the motor vehicle.

Overall, it can be recognized that for example, at least one movement of the shaft is effected, by means of the electric motor, for example, to avoid the rolling away or excessively fast rolling of the motor vehicle. The movement of the shaft effected by the electric motor is dependent, for example, on the type and design of electric motor, in particular. For example, as the electric motor, an electric motor can be used, which can or does set a holding torque directly and exerts it on the shaft, so that, for example, a quasi-static state is achieved or brought about, not by rapid back and forth rotation, but by the shaft being held by means of the electric motor and thus being secured against rotation. For this purpose, the electric motor exerts the holding torque, as a twisting torque, on the shaft.

In doing so, the braking device is the electric motor provided anyhow, for example, of a motor vehicle designed as a hybrid- or electric car and driven by means of the electric motor. The method according to the invention thus resorts to an electrification of the motor vehicle, in particular provided anyway, and uses a component provided anyway, different from the parking brake, the parking lock and the service brake, in the form of an electric motor, in order to at least restrict rolling away. In this way, it can be realized in a simple, weight and cost-effective manner, that the motor vehicle stands and halts or does not move excessively while the parking lock is engaged.

Another embodiment is characterized in that the braking device has a secondary brake system, actuated by means of a fluid, in particular by means of a liquid, and comprising an electronic brake booster (eKBV), by means of which the rolling away of the motor vehicle is at least restricted, in particular prevented, in such way that the electronic brake booster, independently of the actuation of the electronic brake booster effected by a person such as the driver of the motor vehicle, effects a pressure of the fluid for actuating the braking device. The secondary brake system (SBS) is provided in addition to the actual service brake and thus a redundant brake system, which is used, for example, in order to realize a particularly safe automatic or autonomous driving of the motor vehicle. Thus, also in this embodiment of the invention, a component provided anyhow in the form of the secondary brake system is used in order to avoid the rolling away of the motor vehicle in a cost- and weight effective manner. As a result, the parking lock can be engaged with little load or at least almost no load, so that the parking lock itself can be designed weight and cost effectively.

In order to be able to keep the loads acting on the parking lock particularly low while engaging the parking lock and consequently in order to be able to design the parking lock particularly weight and cost effectively, it is provided in another embodiment of the invention that by means of at least one sensor device, in particular of the motor vehicle, at least one measurement value characterizing a rolling speed of the motor vehicle is recorded, wherein the parking lock is engaged depending on the recorded measurement value. The measurement value is information which is included while the parking brake is engaged, in order to be able to reliably identify, for example, based on the measurement value, whether an excessive speed, in particular rolling speed, of the motor vehicle, exists or not. Thereby, it can be ensured that the parking lock is engaged then and, in particular only while the engagement of the parking lock takes place without the load on the parking lock or only under the lowest load. Furthermore, for example, a logic is used, which ensures that the disengagement of the parking lock is not taking place or only under the lowest load, for example, in such a way that by means of the electric motor, said recess or the transmission shaft is rotated in such a way to relax the first engaged parking lock. As a result, the parking lock can be disengaged load-free or with particularly low-load, which in turn affects the force required by the actuator, in particular for moving the parking lock pawl. Thus, the actuator must provide lower forces and can be dimensioned smaller and cheaper. Also, it is conceivable to change the technology away from the geared engine, which can put high forces, towards a magnet that can represent significantly lower force levels.

In another embodiment of the invention, it is provided that the parking lock is engaged when the measurement value falls below a predetermined threshold. Hereby, it can be ensured that the parking lock is then and preferably engaged only when the motor vehicle is not rolling or at a very low speed of, for example, less than two kilometers per hour.

It has shown to be particularly advantageous if the measurement value comprises a rotational speed of at least one wheel of the motor vehicle and the sensor device at least one wheel speed sensor, by means of which the rotational speed of the wheel is recorded, wherein the parking lock is engaged depending on the recorded rotational speed of the wheel and then in particular engaged when the recorded rotational speed falls below the predetermined threshold value.

A further embodiment is characterized in that the measurement value comprises a rotational speed of a shaft of the motor vehicle, in particular of the engine, designed for driving the motor vehicle, and the sensor device comprises at least one shaft speed sensor, by means of which the rotational speed of the shaft is recorded, wherein the parking lock is engaged, depending on the recorded rotational speed of the shaft, and, for example, is engaged when the recorded rotational speed of the shaft falls below the predetermined threshold value. Thus, for example, information such as the rotational speed of the engine, at least one rotational speed at a gear of a transmission of the motor vehicle, simple or redundant wheel speed sensors andor further information, in particular characterizing the rolling speed of the motor vehicle are included in order to ensure that the parking lock is engaged then and preferably only when the rolling or rolling away of the motor vehicle does not occur at an excessive speed.

In order to ensure that the parking lock is engaged then and only when the rolling of the motor vehicle does not occur at an excessive speed, so that as a result, the parking lock and thus the motor vehicle can be designed overall particularly weight and cost effectively, it is provided in another embodiment of the invention that based on a satellite-based navigation system, a speed of the motor vehicle is determined, wherein the parking lock is engaged depending on the determined speed. The satellite-based navigation system is, for example, GPS (Global Positioning System), wherein the parking lock is engaged, for example, when the determined speed of the motor vehicle falls below the predetermined threshold value.

In another embodiment of the invention, the braking device is deactivated after engaging the parking lock, so that a particularly low-energy and thus cost-effective operation can be realized.

In order to realize a particularly advantageous operation in a simple and cost-effective manner, it is provided in another embodiment of the invention that the rolling away of the motor vehicle is automatically at least restricted, in particular prevented, by means of the braking device, while an electronic computing device of the motor vehicle controls the braking device. In other words, the braking device is controlled or regulated by means of the electronic computing device, in order to thereby at least restrict the rolling away of the motor vehicle while the parking lock is engaged.

In order to achieve a particularly safe operation in a weight and cost-effective manner, it is provided in another embodiment of the invention that the initially moving and thus rolling motor vehicle is automatically braked by means of the electronic computing device of the motor vehicle via the braking device, while the computing device controls the braking device, whereupon by means of the braking device, the rolling away of the motor vehicle is at least restricted. Hereby, for example, an autonomous or automatic or partially autonomous or partially automatic operation of the motor vehicle can be realized, in particular using already existing components, so that the number of parts, the weight and the cost of the motor vehicle can be kept at a particularly low level.

The second aspect of the invention relates to a motor vehicle, in particular a car and preferably a passenger car. The motor vehicle comprises a parking lock, a service brake and a parking brake.

In order to be able to design the motor vehicle particularly weight and cost effectively, according to the invention, an additionally provided braking device, which is different from the service brake, the parking brake and the parking lock, is provided, which is designed in order to at least restrict the rolling away of the motor vehicle, in particular to prevent it while the parking lock is engaged. Thus, the motor vehicle according to the invention is designed, for example, for carrying out a method according to the invention. The advantages and advantageous embodiments of the first aspect of the invention are to be regarded as the advantages and advantageous embodiments of the second aspect of the invention and vice versa.

Further advantages, features and details of the invention result from the following description of a preferred exemplary embodiment and from the drawing. The features and combination of features mentioned above in the description as well as the features and combination of features mentioned below in the FIGURE description andor shown in the single FIGURE alone can be used not only in the respectively specified combination but also in other combinations or alone, without leaving the scope of the invention.

The drawing shows, in the single FIGURE, a flow chart for illustrating a method according to the invention for engaging a parking lock of a motor vehicle.

The single FIGURE shows a flow chart for illustrating a method for engaging a parking lock of the motor vehicle having the parking lock, a service brake and a parking brake, which is designed, for example, as a car, particularly as a passenger car. The motor vehicle further comprises, for example, an electronic computing device, by means of which an electronic stability program for controlling driving dynamics is realized so that critical driving conditions can be counteracted actively and, in particular automatically, by means of the electronic stability program.

The motor vehicle further comprises, for example, at least one sensor device, by means of which, for example, in the first step S1 of the method, at least one measurement value characterizing the speed, in particular a rolling speed, of the motor vehicle is recorded. The sensor device comprises, for example, per wheel of the motor vehicle, at least one wheel speed sensor, by means of which each rotational speed, also referred to as wheel speed, of each wheel is recorded. Based on each wheel speed, the speed can be determined respectively, at which the wheel rotates, respectively. If the speed is 0, for example, it can be recorded that the motor vehicle is at a standstill. Alternatively or additionally, the sensor device comprises, for example, at least one shaft speed sensor, by means of which a rotational speed of at least one shaft of the motor vehicle, also referred to as shaft rotational speed, is recorded. The shaft is, for example, a transmission shaft of a transmission of the motor vehicle. Furthermore, the shaft may be a pinion shaft of an engine designed for operating the motor vehicle. The engine is, for example, an internal combustion engine, in particular a reciprocating piston machine, or alternatively an electric motor, so that the motor vehicle is designed, for example, as a hybrid or electric vehicle. Based on the shaft rotational speed, a speed can be recorded, at which the shaft rotates. If the shaft rotational speed or the speed at which the shaft rotates, is 0, it can be assumed, for example, that the motor vehicle is at its standstill.

Furthermore, it is conceivable that the sensor device has at least one communication element which, for example, can communicate at least indirectly with satellites of a satellite-based navigation system. In this way it is possible, for example, by means of the communication element and by means of the satellite-based navigation system, to determine the speed, also referred to as driving speed, at which the vehicle moves, for example, on the earth or relative to the ground, so that based on the driving speed, it can be determined whether the motor vehicle is at its standstill or moves relative to the ground or along the ground.

As illustrated in the FIGURE by a dashed arrow 10, the sensor device provides, for example, in the first step S1, at least one, in particular an electrical signal, which characterizes the recorded or determined speed. The signal and thus the determined recorded speed are fed into, for example, a system or module 12, wherein the module 12 is realized, for example, by the electronic computing device. By means of module 12, a safe parking of the motor vehicle can be realized in such a way that the motor vehicle can be designed particularly cost and weight effectively.

As will be explained in more detail below, during the method, the parking lock is engaged, while by means of a braking device of the motor vehicle, the rolling away of the motor vehicle is at least restricted, in particular prevented. In order to be able to keep the weight and the cost of the motor vehicle particularly low, as the braking device, an additionally provided braking device of the motor vehicle, different from the service brake, the parking lock and the parking brake, is used.

In the following, for example, an error-free operation of the motor vehicle will be described. In the error-free operation, in the second step S2 of the method, the motor vehicle, for example, initially moving at a certain speed and thus moving relative to the ground, in particular automatically by means of the electronic computing device, is decelerated or slowed down, wherein, for example, the motor vehicle is decelerated or slowed down by means of the electronic stability program. In particular, the motor vehicle is braked to its standstill in the second step S2, for example. For this purpose, for example, the electronic computing device or the electronic stability program provide a decelerating request illustrated by arrow 16, to module 14, by means of which, for example, the motor vehicle is slowed down or decelerated, and thereby slowed down, in particular to a standstill. Module 14 is realized, for example, by the electronic computing device.

At the third step S3 of the method, it is determined or recognized that the speed of the motor vehicle falls below a predetermined threshold value or that the motor vehicle is at a standstill. Thus, for example, at the third step S3, it safely recognized that the motor vehicle is at its standstill. For example, it is recognized, based on said signal, that the speed, at which the motor vehicle moves along the ground, falls below the predetermined threshold value or that the motor vehicle is at its standstill. In the error-free operation, for example, based on the wheel speed sensors or based on the wheel speeds, it is recognized that the motor vehicle is at a standstill or that the speed of the motor vehicle falls below the threshold value.

At the fourth step S4 of the method, the standstill is maintained or the rolling away of the motor vehicle is at least restricted. For example, at the second step S2, if the motor vehicle is decelerated by means of the service brake and thus by means of a pressure of a brake fluid, also referred to as brake pressure, for example, in the fourth step S4, the motor vehicle is decelerated by means of the service brake and thus by means of a pressure of a brake fluid, also referred to as brake pressure, and, for example, in the fourth step S4, via valves of the electronic stability program, the brake pressure is locked or held until the particularly designed parking break as an electric parking brake is closed andor the parking lock is engaged. In other words, at the fourth step S4, in the error-free operation, the motor vehicle is kept at a standstill by means of the brake pressure while the parking lock is engaged andor the parking brake is closed.

At the fifth step S5 of the method, for example, the standstill of the motor vehicle is permanently secured. For this purpose, for example, at the fifth step S5 of the method, in the error-free operation, the hydraulic brake pressure is released or reduced, so that then the closed parking brake andor the engaged parking lock secure the standstill and thus the motor vehicle against undesired rolling away.

For this purpose, for example, there is a data exchange with modules 22 illustrated by arrows 18 and 20, by means of which, for example, the standstill is secured. Modules 22 are realized, for example, by the electronic computing device and are used, for example, to control at least one actuator of the parking brake andor at least one actuator of the parking lock, so that, for example, by means of each actuator, the parking brake or the parking lock can be closed or engaged. By arrow 18, for example, a request to modules 22 is illustrated, so that by means of the modules 22, for example, the parking brake is closed andor the parking lock is engaged. If this is successful, for example, a feedback illustrated by arrow 20 takes place in which the parking brake is closed or the parking lock is engaged.

In the following, an error or an error case of the motor vehicle is described. In this error case, for example, the parking brake has failed because, for example, the electronic stability program that controls the parking brake has failed. In the event of an error, for example, at the second step S2, the motor vehicle is, in particular automatically, decelerated by the electronic computing device, via the above-mentioned braking device, different from the service brake, the parking brake and the parking lock, and in particular slowed down to a standstill, particularly while the parking lock is still disengaged. For this purpose, the braking device comprises, for example, the above-mentioned electric motor designed for driving the motor vehicle andor a secondary brake system (SBS). In the event of an error, in the third step S3, the standstill of the motor vehicle or the circumstance that the speed of the motor vehicle falls below the threshold value, for example, is recognized via redundant wheel speed sensors connected to the secondary brake system andor by the fact, that a rotational speed of the above-mentioned engine, in particular a pinion shaft of the engine, is recorded andor that a transmission output speed of a transmission is recorded. Alternatively or additionally, at the third step S3, the standstill of the motor vehicle or the condition that the speed of the motor vehicle falls below the threshold value, can be recognized based on the speed of the motor vehicle, determined by means of the satellite-based navigation system.

In the event of an error, in the fourth step S4 of the method, the standstill is maintained or the motor vehicle is secured against excessive rolling or rolling away, while the braking device as a braking body at least restricts the rolling away of the motor vehicle. By restricting the rolling away of the motor vehicle, it can be understood that the rolling away or rolling of the motor vehicle is completely prevented, so that the motor vehicle does not move. Furthermore, by restricting the rolling away, it may be understood that a slight movement of the motor vehicle is permitted only at a low speed. In particular, for example, the rolling away of the motor vehicle can be at least restricted by means of the braking device in such a way that the braking device comprises the above-mentioned electric motor, by means of which at least one shaft of the motor vehicle is alternately rotated back and forth. In the event of an error, in the fourth step S4 of the method, the rolling away of the motor vehicle is at least restricted while the parking lock is engaged, wherein the rolling away of the motor vehicle is at least restricted until the parking lock is fully engaged.

In the event of an error, in the fourth step S5 of the method, the braking device is off or deactivated after the parking lock has been engaged, whereby the standstill and thus parking of the motor vehicle can be permanently secured by means of the parking lock.

1-12 (canceled)

13. A method for engaging a parking lock of a motor vehicle comprising:
a service brake and a parking brake, in which the parking lock is engaged, while by means of a braking device of the motor vehicle, the rolling away of the motor vehicle is at least restricted,
wherein as the braking device, an additionally provided parking device of the motor vehicle, different from the service brake and from the parking brake is used.

14. The method according to claim 13, wherein the braking device comprises at least one electric motor designed for driving the motor vehicle, by means of which the rolling away of the motor vehicle is at least restricted in such way that, by means of the electric motor, at least one shaft of the motor vehicle is moved several times alternately in a first rotation direction and in a second rotation direction opposite to the first rotation direction.

15. The method according to claim 13, wherein the braking device has a secondary brake system comprising an electronic brake booster that can be actuated by means of a fluid, by means of which the rolling away of the motor vehicle is restricted, in particular prevented in such way that, the electronic brake booster effects a pressure of the fluid for actuating the braking device, independently of the actuation of the electronic brake booster that is effected by a person.

16. The method according to claim 13, wherein by means of at least one sensor device, at least one measurement value characterizing a rolling speed of the motor vehicle is recorded, wherein the parking lock is engaged, depending on the recorded measurement value.

17. The method according to claim 16, wherein the parking lock is engaged when the measurement value falls below a predetermined threshold value.

18. The method according to claim 16, wherein the measurement value comprises a rotational speed of at least one wheel of the motor vehicle and the sensor device comprises at least one wheel speed sensor, by means of which the rotational speed of the wheel is recorded, wherein the parking lock is engaged, depending on the recorded rotational speed of the wheel.

19. The method according to claim 16, wherein the measurement value comprises a rotational speed of a shaft of the motor vehicle, in particular of the engine of the motor vehicle designed for driving the motor vehicle, and the sensor device comprises at least one shaft speed sensor, by means of which the rotational speed of the shaft is recorded, wherein the parking lock is engaged, depending on the recorded rotational speed of the shaft.

20. The method according to claim 13, wherein based on a satellite-based navigation system, a speed of the motor vehicle is determined, wherein the parking lock is engaged, depending on the determined speed.

21. The method according to claim 13, wherein after engaging the parking lock, the braking device is deactivated.

22. The method according to claim 13, wherein the rolling away of the motor vehicle is automatically at least restricted by means of the braking device, by controlling the braking device with an electronic computing device of the motor vehicle.

23. The method according to claim 22, wherein the initially moving motor vehicle is automatically braked via the braking device by means of the electronic computing device of the motor vehicle, by controlling the braking device with the computing device, whereupon by means of the braking device, the rolling away of the motor vehicle is at least restricted.

24. A Motor vehicle comprising:
a parking lock, a service brake, and a parking brake, wherein a braking device, different from the service brake and from the parking brake, is additionally provided, which is designed to at least restrict the rolling away of the motor vehicle while the parking lock is engaged.
